(19) United States
(12) Patent Application Publication
(10) Pub. No.: US 2015/0046026 A1
(43) Pub. Date: Feb. 12, 2015

(54) ENGINE-OFF LEAK DETECTION BASED ON PRESSURE

(71) Applicant: Ford Global Technologies, LLC, Dearborn, MI (US)

(72) Inventors: Russell Randall Pearce, Ann Arbor, MI (US); Scott A. Bohr, Plymouth, MI (US); Dennis Seung-Man Yang, Canton, MI (US); Aed M. Dudar, Canton, MI (US)

(73) Assignee: Ford Global Technologies, LLC, Dearborn, MI (US)

(21) Appl. No.: 13/962,562

(22) Filed: Aug. 8, 2013

(51) Int. Cl. G07C 5/00

(52) U.S. Cl. CPC G07C 5/00; Y10S 903/903
USPC 701/33.9; 903/903

(57) ABSTRACT

Methods and systems for fuel system leak detection are disclosed. In one example approach, a method comprises, in response to a pressure change in a fuel tank less than a threshold for a duration during engine-off conditions while the tank is sealed off from atmosphere, indicating a leak condition, and in response to a pressure change in the tank greater than the threshold during engine-off conditions while the tank is sealed off from atmosphere, indicating a no-leak condition.

### BACKGROUND/SUMMARY

A vehicle with an engine may include an evaporative emission control system coupled to a fuel system in order to reduce fuel vapor emissions. For example, an evaporative emission control system may include a fuel vapor canister coupled to a fuel tank which includes a fuel vapor adsorbent for capturing fuel vapors from the fuel tank while providing ventilation of the fuel tank to the atmosphere.

Leak testing may be periodically performed on such evaporative emission control systems in order to identify leaks in the system so that maintenance may be performed and mitigating actions may be taken in order to reduce emissions. In some approaches, leak testing may be performed using active leak testing systems which include various components such as one or more pumps. For example, an evaporative leak testing module (ELCM) may be included in a vehicle to determine leak testing based on a reference orifice size. In other approaches, vacuum generated during engine operation, e.g., via vacuum in an engine intake manifold, may be provided to the evaporative emission control system for leak testing.

The inventors herein have recognized that such approaches to leak testing may not be capable of detecting leaks with a size less than a threshold size, e.g. such systems may not be capable of detecting 0.010″ orifice leaks due to limitations of components in the leak detection system. For example, an ELCM may only be able to detect leaks with an orifice size greater than or equal to 0.020″. The inability of leak detection systems to detect such small leaks may lead to increased emissions and potential degradation of engine operation due to undetected leaks. Further, the inventors herein have recognized that, in hybrid vehicle applications, engine run-time may be limited so that vacuum generated by engine operation, e.g., via the intake manifold, may not be available for leak testing when a hybrid vehicle is operated in an engine-off mode.

In order to at least partially address these issues, methods for leak testing during engine-off conditions based on pressure changes in a fuel tank are provided. In one example approach, a method comprises, in response to a pressure change in a fuel tank less than a threshold for a duration during engine-off conditions while the tank is sealed off from atmosphere, indicating a leak condition, and in response to a pressure change in the tank greater than the threshold during engine-off conditions while the tank is sealed off from atmosphere, indicating a no-leak condition.

In this way, pressure changes in a sealed fuel tank during engine-off conditions may be used to determine if a leak is present in an evaporative emission control system or a fuel tank. For example, during vehicle operation in an engine-off mode, increases or decreases in temperature of the fuel tank may occur, e.g., due to diurnal temperature changes or heat provided to the fuel system via various vehicle components. If a leak is not present in the sealed fuel tank, pressure changes in the fuel tank will occur due to the temperature changes in the fuel tank. However, if a leak is present, then pressure in the fuel tank may remain substantially unchanged, e.g., at atmospheric pressure, even when temperature changes occur in the fuel system. Thus, by monitoring pressure in the fuel system during engine-off conditions, leak conditions or no-leak conditions may be identified. In such an approach, leak detection for very small leaks, e.g., leaks with a size less than a threshold detectable by leak diagnostic components such as an ELCM, may be achieved. Further, in such an approach leak detection may be performed without additional components such as additional pumps, fuel reservoirs, leak check modules, etc., thereby potentially reducing costs associated with additional leak diagnostic components. Further, in some examples, such an approach may be used in addition to other leak diagnostic approaches to increase accuracy of leak testing and/or as an initial screening, e.g., to determine if a potential leak is present before performing an active leak test which consumes power or performing a leak test during vehicle operation in an engine-on mode.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example vehicle propulsion system.

FIG. 2 shows an example vehicle system with a fuel emission control system.

FIG. 3 shows an example method for leak testing during engine-off conditions based pressure changes in accordance with the disclosure.

FIG. 4 illustrates leak testing during engine-off conditions based pressure changes in a fuel tank in accordance with the disclosure.

### DETAILED DESCRIPTION

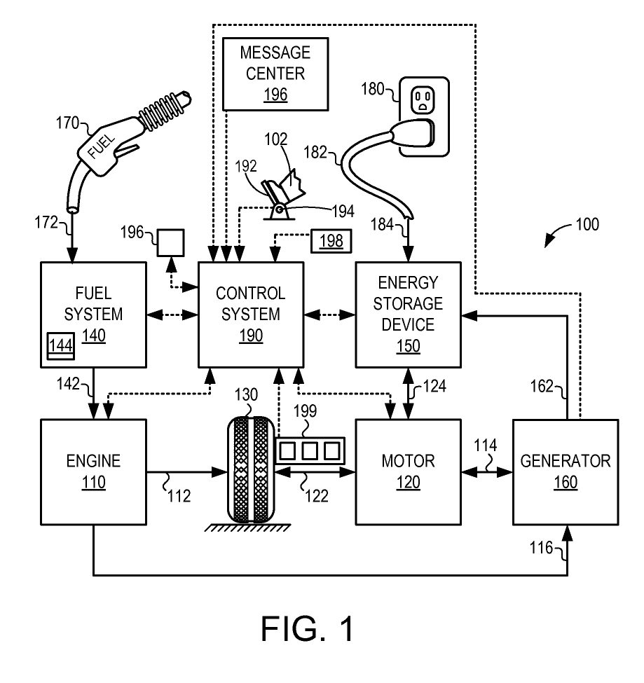

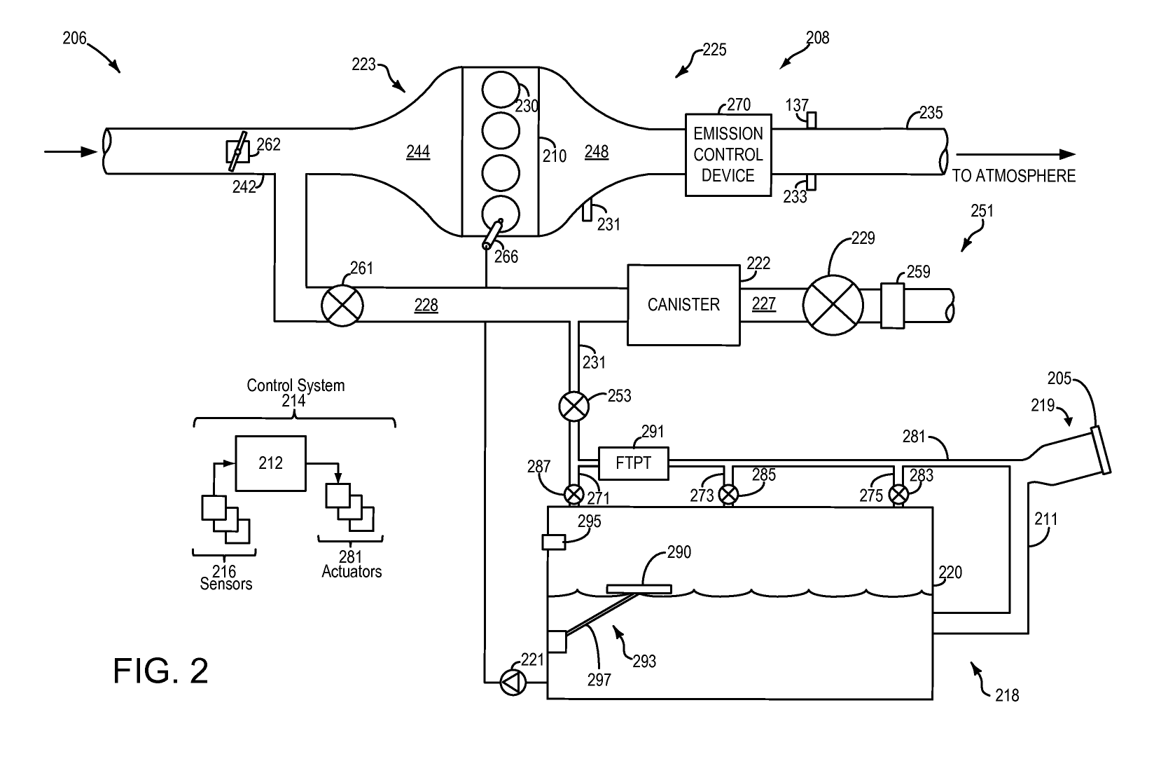

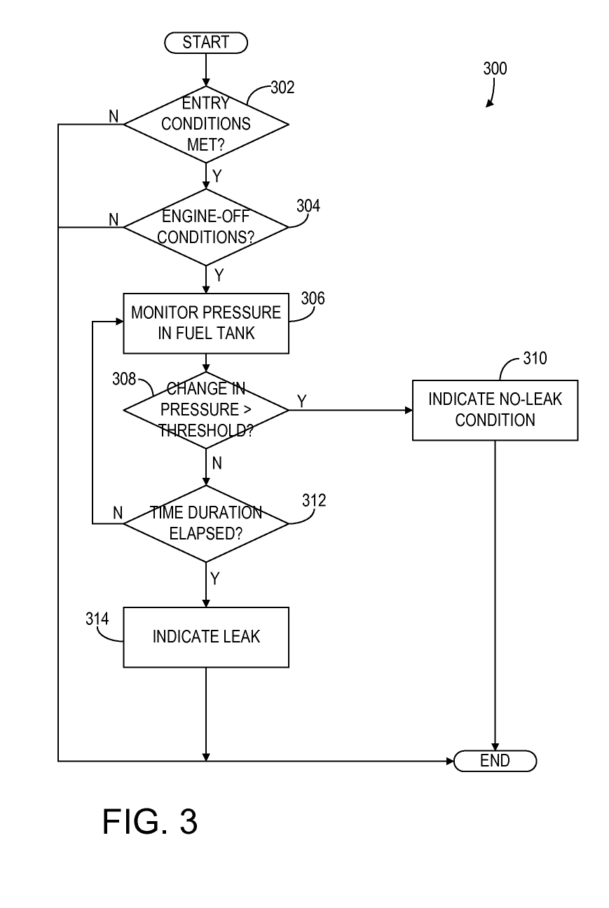

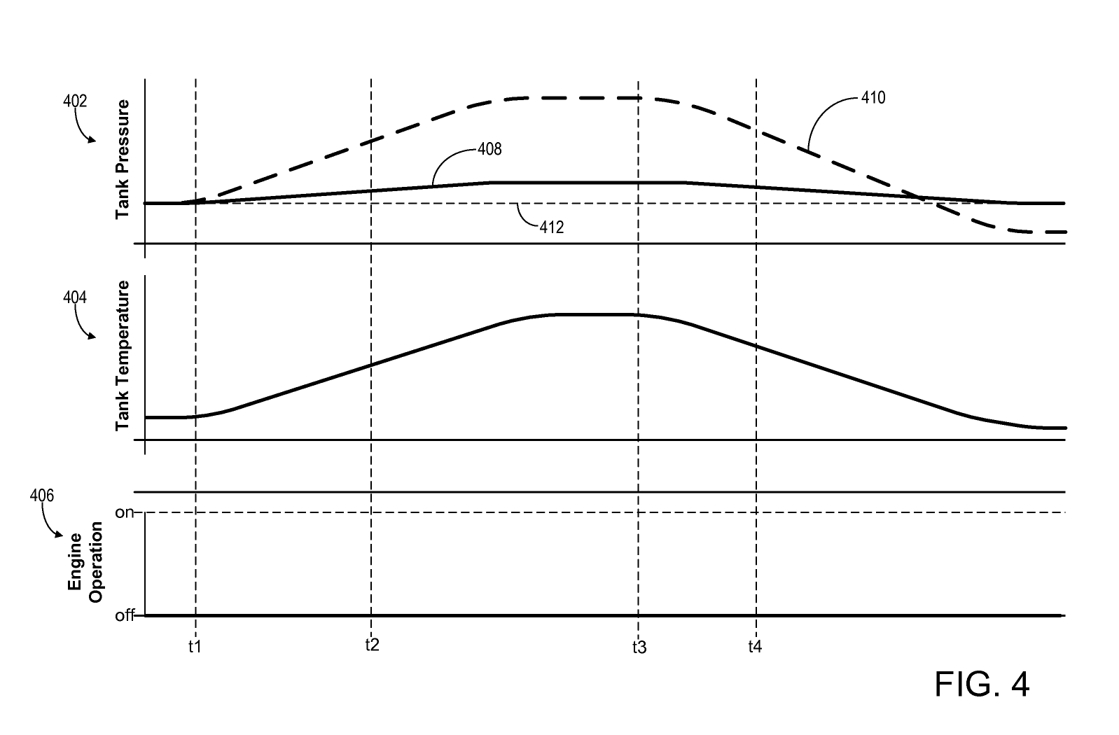

The following description relates to systems and methods for performing leak diagnostics in a vehicle system with an engine, such as the vehicle shown in FIG. 1 and the engine system shown in FIG. 2. During engine-off conditions, a fuel tank may be sealed off from the atmosphere, sealed from an engine intake, and sealed any other gas port so that, if no-leaks are present, any temperature changes which occur in the fuel tank lead to associated pressure changes in the fuel tank. However, if a leak is present in the sealed fuel tank, then no substantial pressure changes may occur in the fuel tank during engine-off conditions, e.g., pressure in the fuel tank may remain at substantially atmospheric pressure. Thus, as shown in FIGS. 3 and 4, during engine-off conditions, pressure in the fuel tank may be monitored so that a no-leak condition may be identified in response to pressure changes in the fuel tank and a leak condition may be identified in response to no substantial change in pressure in the fuel tank.

Turning now to the figures, FIG. 1 illustrates an example vehicle propulsion system 100. Vehicle propulsion system 100 includes a fuel burning engine 110 and a motor 120. As a non-limiting example, engine 110 comprises an internal combustion engine and motor 120 comprises an electric motor. Motor 120 may be configured to utilize or consume a different energy source than engine 110. For example, engine 110 may consume a liquid fuel (e.g. gasoline) to produce an engine output while motor 120 may consume electrical energy to produce a motor output. As such, a vehicle with propulsion system 100 may be referred to as a hybrid electric vehicle (HEV).

Vehicle propulsion system 100 may utilize a variety of different operational modes depending on operating conditions encountered by the vehicle propulsion system. Some of these modes may enable engine 110 to be maintained in an off state (i.e. set to a deactivated state) where combustion of fuel at the engine is discontinued. For example, under select operating conditions, motor 120 may propel the vehicle via drive wheel 130 as indicated by arrow 122 while engine 110 is deactivated.

During other operating conditions, engine 110 may be set to a deactivated state (as described above) while motor 120 may be operated to charge energy storage device 150. For example, motor 120 may receive wheel torque from drive wheel 130 as indicated by arrow 122 where the motor may convert the kinetic energy of the vehicle to electrical energy for storage at energy storage device 150 as indicated by arrow 124. This operation may be referred to as regenerative braking of the vehicle. Thus, motor 120 can provide a generator function in some embodiments. However, in other embodiments, generator 160 may instead receive wheel torque from drive wheel 130, where the generator may convert the kinetic energy of the vehicle to electrical energy for storage at energy storage device 150 as indicated by arrow 162.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, motor 120 may propel the vehicle via a first set of drive wheels and engine 110 may propel the vehicle via a second set of drive wheels.

In other embodiments, vehicle propulsion system 100 may be configured as a series type vehicle propulsion system, whereby the engine does not directly propel the drive wheels. Rather, engine 110 may be operated to power motor 120, which may in turn propel the vehicle via drive wheel 130 as indicated by arrow 122. For example, during select operating conditions, engine 110 may drive generator 160, which may in turn supply electrical energy to one or more of motor 120 as indicated by arrow 114 or energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor.

Fuel system 140 may include one or more fuel storage tanks 144 for storing fuel on-board the vehicle. For example, fuel tank 144 may store one or more liquid fuels, including but not limited to: gasoline, diesel, and alcohol fuels. In some examples, the fuel may be stored on-board the vehicle as a blend of two or more different fuels. For example, fuel tank 144 may be configured to store a blend of gasoline and ethanol (e.g. E10, E85, etc.) or a blend of gasoline and methanol (e.g. M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some embodiments, energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, energy storage device 150 may include one or more batteries and/or capacitors.

Control system 190 may communicate with one or more of engine 110, motor 120, fuel system 140, energy storage device 150, and generator 160. As will be described by the process flow of FIG. 3, control system 190 may receive sensory feedback information from one or more of engine 110, motor 120, fuel system 140, energy storage device 150, and generator 160. Further, control system 190 may send control signals to one or more of engine 110, motor 120, fuel system 140, energy storage device 150, and generator 160 responsive to this sensory feedback. Control system 190 may receive an indication of an operator requested output of the vehicle propulsion system from a vehicle operator 102. For example, control system 190 may receive sensory feedback from pedal position sensor 194 which communicates with pedal 192. Pedal 192 may refer schematically to a brake pedal and/or an accelerator pedal.

Energy storage device 150 may periodically receive electrical energy from a power source 180 residing external to the vehicle (e.g. not part of the vehicle) as indicated by arrow 184. As a non-limiting example, vehicle propulsion system 100 may be configured as a plug-in hybrid electric vehicle (HEV), whereby electrical energy may be supplied to energy storage device 150 from power source 180 via an electrical energy transmission cable 182. During a recharging operation of energy storage device 150 from power source 180, electrical transmission cable 182 may electrically couple energy storage device 150 and power source 180. While the vehicle propulsion system is operated to propel the vehicle, electrical transmission cable 182 may disconnected between power source 180 and energy storage device 150. Control system 190 may identify and/or control the amount of electrical energy stored at the energy storage device, which may be referred to as the state of charge (SOC).

In other embodiments, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it should be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some embodiments, fuel tank 144 may be configured to store the fuel received from fuel dispensing device 170 until it is supplied to engine 110 for combustion. In some embodiments, control system 190 may receive an indication of the level of fuel stored at fuel tank 144 via a fuel level sensor. The level of fuel stored at fuel tank 144 (e.g. as identified by the fuel level sensor) may be communicated to the vehicle operator, for example, via a fuel gauge or indication lamp indicated at 196.

The vehicle propulsion system 100 may also include a message center 196, ambient temperature/humidity sensor 198, and a roll stability control sensor, such as a lateral and/or longitudinal and/or yaw rate sensor(s) 199. The message center may include indicator light(s) and/or a text-based display in which messages are displayed to an operator. The message center may also include various input portions for receiving an operator input, such as buttons, touch screens, voice input/recognition, etc. In an alternative embodiment, the message center may communicate audio messages to the operator without display. Further, the sensor(s) 199 may include a vertical accelerometer to indicate road roughness. These devices may be connected to control system 190. In one example, the control system may adjust engine output and/or the wheel brakes to increase vehicle stability in response to sensor(s) 199.

FIG. 2 shows a schematic depiction of a vehicle system 206. The vehicle system 206 includes an engine system 208 coupled to an emissions control system 251 and a fuel system 218. Emission control system 251 includes a fuel vapor canister 222 which may be used to capture and store fuel vapors. In some examples, vehicle system 206 may be a hybrid electric vehicle system such as the vehicle system shown in FIG. 1. However, in other examples, vehicle system 206 may not be a hybrid electric vehicle system.

The engine system 208 may include an engine 210 having a plurality of cylinders 230. The engine 210 includes an engine intake 223 and an engine exhaust 225. The engine intake 223 includes a throttle 262 fluidly coupled to the engine intake manifold 244 via an intake passage 242. The engine exhaust 225 includes an exhaust manifold 248 leading to an exhaust passage 235 that routes exhaust gas to the atmosphere. The engine exhaust 225 may include one or more emission control devices 270, which may be mounted in a close-coupled position in the exhaust. One or more emission control devices may include a three-way catalyst, lean NOx trap, diesel particulate filter, oxidation catalyst, etc. It will be appreciated that other components may be included in the engine such as a variety of valves and sensors.

Fuel system 218 may include a fuel tank 220 coupled to a fuel pump system 221. The fuel pump system 221 may include one or more pumps for pressurizing fuel delivered to the injectors of engine 210, such as the example injector 266 shown. While only a single injector 266 is shown, additional injectors are provided for each cylinder. It will be appreciated that fuel system 218 may be a return-less fuel system, a return fuel system, or various other types of fuel system.

Fuel tank 220 may include a fuel level sensor 203 configured to determine a fuel level or amount of liquid fuel contained in the fuel tank. For example, fuel level sensor 293 may include a float 290 coupled to an arm 297 so that a height of liquid fuel in the tank may be determined to infer the volume of liquid fuel in the tank. Fuel tank 220 may additionally include one or more temperature sensors. For example, fuel tank 220 may include a temperature sensor 295 for determining a temperature of the vapor space above the liquid fuel in the tank.

Vapors generated in fuel system 218 may be routed to an evaporative emissions control system 251 which includes a fuel vapor canister 222 via vapor recovery line 231, before being purged to the engine intake 223. Vapor recovery line 231 may be coupled to fuel tank 220 via one or more conduits and may include one or more valves for isolating the fuel tank during certain conditions. For example, vapor recovery line 231 may be coupled to fuel tank 220 via one or more or a combination of conduits 271, 273, and 275. Further, in some examples, one or more fuel tank isolation valves may be included in recovery line 231 or in conduits 271, 273, or 275. Among other functions, fuel tank isolation valves may allow a fuel vapor canister of the emissions control system to be maintained at a low pressure or vacuum without increasing the fuel evaporation rate from the tank (which would otherwise occur if the fuel tank pressure were lowered). For example, conduit 271 may include a grade vent valve (GVV) 287, conduit 273 may include a fill limit venting valve (FLVV) 285, and conduit 275 may include a grade vent valve (GVV) 283, and/or conduit 231 may include an isolation valve 253. Further, in some examples, recovery line 231 may be coupled to a fuel filler system 219. In some examples, fuel filler system may include a fuel cap 205 for sealing off the fuel filler system from the atmosphere. However, in other examples, fuel filler system 219 may be a capless fuel filler system. Refueling system 219 is coupled to fuel tank 220 via a fuel filler pipe or neck 211.

A fuel tank pressure transducer (FTPT) 291, or fuel tank pressure sensor, may be included between the fuel tank 220 and fuel vapor canister 222, to provide an estimate of a fuel tank pressure. As described below, in some examples, sensor 291 may be used to monitor changes in pressure and/or vacuum in the fuel system to determine if a leak is present. The fuel tank pressure transducer may alternately be located in vapor recovery line 231, purge line 228, vent line 227, or other location within emission control system 251 without affecting its engine-off leak detection ability.

Emissions control system 251 may include one or more emissions control devices, such as one or more fuel vapor canisters 222 filled with an appropriate adsorbent, the canisters are configured to temporarily trap fuel vapors (including vaporized hydrocarbons) during fuel tank refilling operations and “running loss” (that is, fuel vaporized during vehicle operation). In one example, the adsorbent used is activated charcoal. Emissions control system 251 may further include a canister ventilation path or vent line 227 which may route gases out of the canister 222 to the atmosphere when storing, or trapping, fuel vapors from fuel system 218.

Vent line 227 may also allow fresh air to be drawn into canister 222 when purging stored fuel vapors from fuel system 218 to engine intake 223 via purge line 228 and purge valve 261. For example, purge valve 261 may be normally closed but may be opened during certain conditions so that vacuum from engine intake 244 is provided to the fuel vapor canister for purging. In some examples, vent line 227 may include an air filter 259 disposed therein upstream of a canister 222. In some examples, an evaporative leak check module (ELCM) may be included in the fuel system or evaporative emissions control system. For example, an ELCM may be disposed in vent conduit 227 and may be configured to assist in leak diagnostics. For example, an ELCM may include a pump which is operated to determine a reference pressure based on a predetermined orifice size so that leaks may be detected by monitoring pressure in the emissions control system relative to the reference pressure. However, in some examples, vehicle system 206 may not include an ELCM and may instead only perform leak testing based on a fuel level and pressure in the fuel tank as described below with regard to FIGS. 3 and 4.

Flow of air and vapors between canister 222 and the atmosphere may be regulated by a canister vent valve 229. Canister vent valve may be a normally open valve so that fuel tank isolation valve 253 may be used to control venting of fuel tank 220 with the atmosphere. For example, in hybrid vehicle applications, isolation valve 253 may be a normally closed valve so that by opening isolation valve 253, fuel tank 220 may be vented to the atmosphere and by closing isolation valve 253, fuel tank 220 may be sealed from the atmosphere. In some examples, isolation valve 253 may be actuated by a solenoid so that, in response to a current supplied to the solenoid, the valve will open. For example, in hybrid vehicle applications, the fuel tank 220 may be sealed off from the atmosphere in order to contain diurnal vapors inside the tank since the engine run time is not guaranteed. Thus, for example, isolation valve 253 may be a normally closed valve which is opened in response to certain conditions. For example, isolation valve 253 may be commanded open during a refueling event.

The vehicle system 206 may further include a control system 214. Control system 214 is shown receiving information from a plurality of sensors 216 (various examples of which are described herein) and sending control signals to a plurality of actuators 281 (various examples of which are described herein). As one example, sensors 216 may include exhaust gas sensor 237 located upstream of the emission control device, temperature sensor 295, fuel level sensor 293, and pressure sensor 291. Other sensors such as pressure, temperature, air/fuel ratio, and composition sensors may be coupled to various locations in the vehicle system 206. As another example, the actuators may include fuel injector 266, throttle 262, fuel tank isolation valve 253, and pump 221. The control system 214 may include a controller 212. The controller may receive input data from the various sensors, process the input data, and trigger the actuators in response to the processed input data based on instruction or code programmed therein corresponding to one or more routines. An example control routine is described herein with regard to FIG. 3.

FIG. 3 shows an example method 300 for performing leak diagnostics based on pressure in a fuel tank during engine-off conditions. For example, method 300 may be used to diagnose very small leaks, e.g., leaks with a size less than a threshold detectable by leak diagnostic components such as an ELCM. In some examples, the leak detection routine shown in FIG. 3 may be solely used to diagnose leaks in an evaporative emission control system, e.g., in a vehicle system which does not include an ELCM. However, in other examples, method 300 may be used in addition to other leak diagnostic approaches to increase accuracy of leak testing and/or as an initial screening, e.g., to determine if a potential leak is present before performing an active leak test which consumes power of before performing a leak test during engine-on conditions. Since method 300 may be performed based only on pressure readings, e.g., via sensor 291, it may be desirable to first perform leak testing using method 300 and then, if a leak is indicated, perform an additional leak test, e.g., using an active leak detection system or a leak test performed during engine-on conditions. In this way, frequency of leak testing performed by power or fuel consuming components may be reduced.

At 302, method 300 includes determining if entry conditions for leak testing are met. Entry conditions may be based on temperatures in the fuel system or evaporative emission control system, For example, entry conditions may include determining if a temperature in the fuel system is in a predetermined range of temperatures. For example, if the temperatures are below a lower temperature threshold or above an upper temperature threshold then method 300 may end. As another example, entry conditions for performing a leak test may be based on when a previous leak test was performed. For example, leak tests may be scheduled to occur at predetermined time intervals or following a prescribed schedule thus may be based on a time duration greater than a threshold time duration since a previous leak test was performed. Further, entry conditions may include vehicle operating conditions where the fuel tank is sealed, e.g., sealed off from the atmosphere, sealed off from the engine intake, and sealed off from any other gas ports. For example, fuel tank isolation valve 253 may be in a closed position to seal off the fuel tank. As another example, a canister vent valve, e.g., valve 229, may be closed or maintained in a closed position to that the fuel tank is not in communication with the atmosphere. In some examples, the fuel tank may remain sealed off from the atmosphere except during certain conditions, such as during a refueling event when the engine is off. Thus, entry conditions may also be based on whether or not refueling is taking place.

If entry conditions are met at 302, method 300 proceeds to 304. At 304, method 300 includes determining if engine-off conditions are present. Engine-off conditions may include any vehicle conditions where the engine is not in operation. In some examples, engine-off conditions may be based on a vehicle operator input, e.g., a vehicle operator may perform a key-off or press an engine-off button to initiate engine-off conditions. As another example, a hybrid electric vehicle may transition from engine-on conditions, where the vehicle is propelled by engine operation to engine-off conditions, where the engine is off but the vehicle is propelled via an auxiliary power source. If engine-off conditions are present at 304, method 300 proceeds to 306.

At 306, method 300 includes, monitoring pressure in the fuel tank. For example, the pressure in the fuel tank may be monitored via FTPT sensor 291 during the engine-off conditions to determine if a change in pressure occurs in the fuel tank while it is sealed off from the atmosphere, the engine intake, and any other gas ports.

At 308, method 300 includes determining if pressure in the fuel tank changes by at least a threshold amount. The threshold amount of pressure change may be a predetermined threshold amount of pressure increase or decrease such that if pressure increases or decreases more than this threshold amount then a no-leak condition is indicated whereas if the pressure change is less than this threshold amount for a duration then a leak condition is indicated. For example, the pressure change may be a change in pressure from atmospheric pressure such that if the pressure in the fuel tank remains substantially at atmospheric pressure for a predetermined time duration then a leak may be present in the fuel tank.

If pressure in the fuel tank changes by at least the threshold amount at 308, method 300 proceeds to 310 to indicate a no-leak condition. For example, a no-leak condition may be indicated in response to a pressure increase in the fuel tank greater than a threshold during increasing temperature conditions in the fuel tank. As another example, a no-leak condition may be indicated in response to a pressure decrease in the fuel tank greater than a threshold during decreasing temperature conditions in the fuel tank. Indicating a no-leak condition may include setting a diagnostic code in an onboard diagnostics system in the vehicle indicating that the fuel system is leak free.

However, if pressure in the fuel tank does not change by at least the threshold amount, then method 300 proceeds to 312 to determine if a time duration has elapsed. For example, the time duration may be a time duration during which temperature of the fuel tank changes by a threshold amount. If the time duration has not elapsed at 312, method 300 continues monitoring the pressure in the fuel tank during engine-off conditions at 306. However, if the time duration has elapsed at 312, then method 300 proceeds to 314 to indicate a leak. For example, a leak condition may be indicated in response to a pressure increase in the fuel tank less than the threshold for a duration during increasing temperature conditions in the fuel tank. As another example, a leak condition may be indicated in response to a pressure decrease in the fuel tank less than the threshold for a duration during decreasing temperature conditions in the fuel tank. In particular, if the pressure in the fuel tank does not change substantially even during temperature increasing or decreasing conditions, e.g., if the pressure in the fuel tank remains substantially equal to atmospheric pressure for a duration, then a leak may be indicated. Indicating a leak may further include indicating a degradation of the fuel system so that mitigating actions may be performed. For example, a diagnostic code may be set in an onboard diagnostics system in the vehicle and/or a message may be sent to a message center in the vehicle to alert a vehicle operator of the degradation in the fuel system.

FIG. 4 illustrates an example method, e.g., method 300, for performing leak diagnostics based on pressure in a fuel tank during engine-off conditions. Graph 402 shows fuel tank pressure, e.g., a measured via pressure sensor 291, versus time for a fuel tank with no leak (indicated by curve 410) and for a fuel tank with a leak (indicated by curve 408). Graph 404 shows fuel tank temperature versus time and graph 406 shows engine operation versus time.

As indicated in graph 406, the vehicle is operating in an engine-off mode throughout the duration of the illustrated vehicle operation. At time t1 the temperature of the fuel tank begins to increase, e.g., due to heat provided to the fuel tank via vehicle components or due to ambient temperature increases. Between times t1 and t2 the fuel tank temperature changes by a threshold amount. In this example, the fuel tank is sealed off from the atmosphere, sealed off from the engine intake, and sealed off from any other gas port, so that if a leak is not present in the fuel tank, the pressure will increase in the fuel tank proportionally to the increase in temperature. Since a pressure increase is observed in the fuel tank as shown in curve 410, a no-leak condition is indicated. However, the pressure in the fuel tank remains substantially unchanged in the example pressure curve 408, e.g., remains at or near atmospheric pressure 412 even though the temperature is increasing in the fuel tank. Thus, after the time duration from t1 to t2 when the temperature changes by a threshold amount, a leak condition may be indicated for the fuel tank with pressure curve 408.

At time t3, the temperature of the fuel tank begins to decrease during vehicle operation in engine-off mode, e.g., due to a decreasing ambient temperature. Between times t3 and t4, temperature in the fuel tank decreases by a threshold amount. In the example curve 410, pressure in the fuel tank decreases by an amount proportional to the temperature decrease amount indicating that no leak is present in the tank. However, in the fuel tank pressure curve 408, the fuel tank pressure remains substantially unchanged, e.g., at or near atmospheric pressure, for a duration from time t3 to t4. Since the pressure does not significantly change, e.g., the change in pressure in the fuel tank is less than a threshold in curve 408, a leak is indicated in the tank.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a vehicle with an engine, comprising:
in response to a pressure change in a fuel tank less than a threshold for a duration during engine-off conditions while the tank is sealed off from atmosphere, indicating a leak condition; and
in response to a pressure change in the tank greater than the threshold during engine-off conditions while the tank is sealed off from atmosphere, indicating a no-leak condition.

2. The method of claim 1, wherein the duration is time duration during which temperature of the fuel tank changes by a threshold amount.

3. The method of claim 1, wherein the engine-off conditions occur during vehicle operation.

4. The method of claim 1, wherein the engine-off conditions occur during vehicle operation while the vehicle is in motion.

5. The method of claim 1, wherein the vehicle is a hybrid electric vehicle.

6. The method of claim 1, wherein the pressure change is a change in pressure from atmospheric pressure.

7. The method of claim 1, further comprising indicating a no-leak condition in response to a pressure increase in the fuel tank greater than a threshold during increasing temperature conditions in the fuel tank and indicating a leak condition in response to a pressure increase in the fuel tank less than the threshold for a duration during increasing temperature conditions in the fuel tank.

8. The method of claim 1, further comprising indicating a no-leak condition in response to a pressure decrease in the fuel tank greater than a threshold during decreasing temperature conditions in the fuel tank and indicating a leak condition in response to a pressure decrease in the fuel tank less than the threshold for a duration during decreasing temperature conditions in the fuel tank.

9. The method of claim 1, wherein the fuel tank is sealed off from an engine intake and any other gas port during the engine-off conditions.

10. A method for a hybrid electric vehicle with an engine, comprising:
during engine-off conditions while a fuel tank is sealed off from an engine intake and any other gas port, indicating a leak in response to a pressure change in the fuel tank less than a threshold for a duration.

11. The method of claim 10, further comprising, during engine-off conditions while the fuel tank is sealed off from the engine intake and any other gas port, indicating a no-leak condition in response to a pressure change in the fuel tank greater than the threshold.

12. The method of claim 10, wherein the duration is time duration during which temperature of the fuel tank changes by a threshold amount.

13. The method of claim 10, wherein the engine-off conditions occur during vehicle operation while the vehicle is in motion.

14. The method of claim 10, wherein the pressure change is a change in pressure from atmospheric pressure.

15. The method of claim 10, further comprising indicating a no-leak condition in response to a pressure increase in the fuel tank greater than a threshold during increasing temperature conditions in the fuel tank and indicating a leak condition in response to a pressure increase in the fuel tank less than the threshold for a duration during increasing temperature conditions in the fuel tank.

16. The method of claim 10, further comprising indicating a no-leak condition in response to a pressure decrease in the fuel tank greater than a threshold during decreasing temperature conditions in the fuel tank and indicating a leak condition in response to a pressure decrease in the fuel tank less than the threshold for a duration during decreasing temperature conditions in the fuel tank.

17. A method for a hybrid electric vehicle with an engine, comprising:
during engine-off conditions while a fuel tank is sealed off from an engine intake, atmosphere, and any other gas port, indicating a leak in response to a pressure change in the fuel tank less than a threshold for a duration, where the duration is a time duration during which temperature of the fuel tank changes by a threshold amount; and
during engine-off conditions while the fuel tank is sealed off from the engine intake and any other gas port, indicating a no-leak condition in response to a pressure change in the fuel tank greater than the threshold.

18. The method of claim 17, wherein the pressure change is a change in pressure from atmospheric pressure.

19. The method of claim 17, wherein the vehicle is a plug-in hybrid electric vehicle.

20. The method of claim 17, wherein the engine-off conditions occur during vehicle operation while the vehicle is in motion.
